(19) United States
(12) Patent Application Publication
(10) Pub. No.: US 2010/0030609 A1
(43) Pub. Date: Feb. 4, 2010

(54) INTELLIGENT SYSTEM AND FUZZY LOGIC BASED METHOD TO DETERMINE PROJECT RISK

(75) Inventors: Sri Ramanathan, Lutz, FL (US); Padmashri Suresh, Karnataka (IN); Matthew B. Trevathan, Kennesaw, GA (US); Balaji Venkatraman, Karnataka, TX (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/183,286

(22) Filed: Jul. 31, 2008

(51) Int. Cl. G06Q 10/00

(52) U.S. Cl. 705/9

(57) ABSTRACT

A method, service, and product for changing project length based on fuzzy logic techniques where a subject matter expert assigns a pre-determined risk rating to each of a set of tasks. A fuzzy engine assigns a human grammar to each of the pre-determined risk ratings for each of the set of tasks, the human grammar being defined by a numeric range and assigned to the risk rating for each value falling within the numeric range. The fuzzy engine determines which rules from a set of rules apply to the task with the assigned human grammar, the set of rules being preprogrammed into the fuzzy engine, which then evaluates the tasks with the assigned human grammar using the determined rules. The fuzzy engine thereafter creates an adjusted-time allocation for each task and creates an adjusted-task-length for the set of tasks based from all of the created adjusted time allocations.

### FIELD OF THE INVENTION

The present invention generally describes an intelligent system and fuzzy logic-based method to determine an overall adjusted project length based on risk.

### BACKGROUND OF THE INVENTION

Project planning is the discipline of planning, organizing, and managing resources to bring about the successful completion of specific project goals and objectives. The primary challenge of project management is to achieve all of the project goals and objectives while adhering to classic project constraints, for example, scope, quality, time, and budget. A secondary challenge is to optimize the allocation and integration of inputs necessary to meet pre-defined objectives, for example, using resources (e.g. labor, materials, energy, space, provisions, and communications) in the most efficient manner to achieve the project goals and objectives.

Risk management, a component of project management, is a structured approach to managing uncertainty related to a project task. Strategies to manage risk may generally include transferring a risk to another party, reducing any negative effect of a risk, accepting some or all of the consequences of a particular risk, or avoiding a risk altogether. An objective of risk management is to reduce different risks for a given project to a level accepted by society.

Generally in many service organizations, a considerable amount of effort and money is spent on managing the risk associated with projects. This is particularly relevant in today's complex delivery environment where a large portion of projects are deemed as being at risk, causing elevated costs and expenses to both producers and consumers. As part of a general standard delivery cycle, a good assessment of the technical risk associated with the delivery of the project is very important for accurate sizing and pricing. Technical risk assessment processes may alter project schedules drastically when projects are deemed a higher risk, to the point of halting a given project.

Calculating task times during a technical risk assessment process may occur generally through a deductive process, for example, by factoring in an overall completion date and assigning weights to each project task. Another example of time calculation includes calculating estimates based on schedule changes in prior or parallel tasks. A further deductive calculating example includes the use of neural networks to assign weights and contributing factors to tasks and their dependent tasks. These methods require finite risk values and do not generally allow for fluid scheduling changes based on changing risk factors.

Thus, there is a need for improved methods and systems that address the above problems, as well as others.

### SUMMARY OF THE INVENTION

A method, service, and product are provided for changing project length based on fuzzy logic techniques where a subject matter expert assigns a pre-determined risk rating to each of a set of tasks. A fuzzy engine assigns a human grammar to each of the pre-determined risk ratings for each of the set of tasks; the human grammar being defined by a numeric range and assigned to the risk rating for each value falling within the numeric range. The fuzzy engine determines which rules from a set of rules apply to the task with the assigned human grammar; the set of rules being preprogrammed into the fuzzy engine, which then evaluates the tasks with the assigned human grammar using the determined rules. The fuzzy engine thereafter creates an adjusted time allocation for each task based on the evaluation and creates an adjusted task length for the set of tasks based from all of the created adjusted time allocations.

In another aspect, methods are provided for deploying a service for changing project length based on fuzzy logic techniques, for example, by a service provider who offers to implement, deploy, and/or perform functions for others. Still further, an article of manufacture comprising a computer usable storage medium having a computer readable program in said medium may be provided. Such program code comprises instructions which, when executed on a computer system, cause the computer system to perform one or more method and/or process elements for changing project length based on fuzzy logic techniques, for example, as described above. Moreover, systems, articles and programmable devices configured for performing one or more method and/or process elements of the current invention for recycling a material as a function of interactively determining an appropriate category, for example, as described above, are also provided.

### BRIEF DESCRIPTION OF THE DRAWINGS

These and other features of this invention will be more readily understood from the following detailed description of the various aspects of the invention taken in conjunction with the accompanying drawings in which:

These and other features of this invention will be more readily understood from the following detailed description of the various aspects of the invention taken in conjunction with the accompanying drawings in which:

FIG. 1 is a flow chart illustrating a process for determining an overall project task length based on risk by an intelligent system using a fuzzy logic method.

FIG. 2 is a flow chart illustrating one embodiment for determining an overall project task length based on risk by an intelligent system using a fuzzy logic method.

FIG. 3 is a block diagram illustrating a system or device which determines an overall project task length based on risk by an intelligent system using a fuzzy logic method.

FIG. 4 is a block diagram illustrating an exemplary computerized implementation of a process and system which determines an overall project task length based on risk by an intelligent system using a fuzzy logic method.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections:

I. General Description

II. Computerized Implementation

### I. General Description

Planning a project relates to the use of schedules to plan within a project environment. Initially, the project scope is defined and the appropriate methods for completing the project are determined. Tasks are also created, these are activities or jobs which have start dates and times, end dates and times, durations, and other scheduling properties. The logical dependencies between tasks also need to be defined. The necessary resources can then be estimated and costs for each activity can be allocated to each resource, giving the total project cost. Progress will be measured against this plan throughout the life of the project.

Fuzzy logic is a mathematical means for handling imprecise concepts and can provide optimal solutions for systems that have a lot of controllable variables, generally where fluid change is necessary. Fuzzy logic solves problems through approximation rather than through precise, predicate logic. With predicate systems, a member is either a full member or not a member of a set, there is no partial membership. Fuzzy logic allows partial memberships in sets and describes these memberships in imprecise linguistic terms like, for example, low, medium, and high.

Modern applications of fuzzy logic center around temperature control, cruise control, and other applications where there are multiple factors controlling the device. In terms of car and cruise control, current speed, hills and wind may affect the overall ability to maintain speed. Fuzzy logic may be used to solve problems in a wide variety of areas, for example: washing machines, complex imaging processing, heating, ventilation and air conditioning (HVAC) systems, and complex work allocation systems.

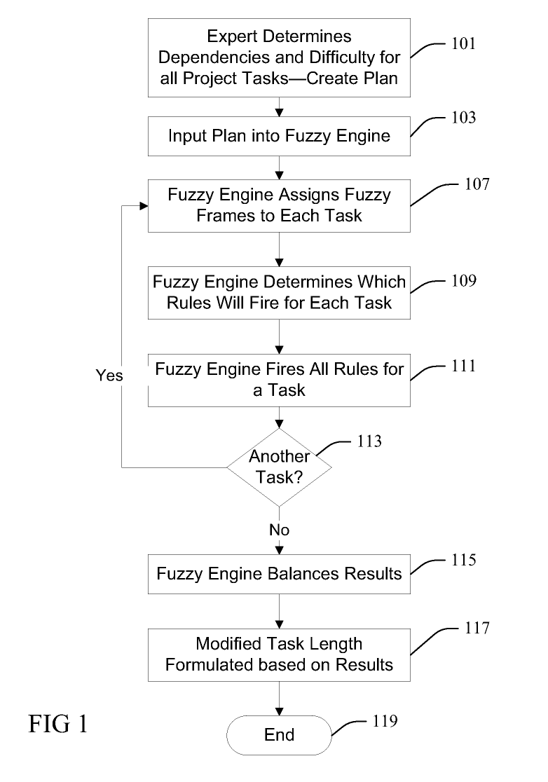

FIG. 1 describes a method for determining an overall project length based on risk using a fuzzy logic method. At 101, a subject matter expert creates a project plan in which the expert assigns a “risk value” for a number of risk factors, for example: for a task's dependency on other tasks, for other task dependency on a given task, and for a confidence level (e.g. level of difficulty). Assigning at 101 may occur through a plurality of apparatuses or software programs. Some embodiments are described more fully below and other examples will be apparent to one skilled in the art, while numerous modifications and substitutions are possible without deviating from the claims of the invention.

A subject matter expert (SME) who assigns the risk values at 101 may be a person who is an expert in a particular area. The term may be used to describe professionals who, for example, have expertise in a field of application but without technical project knowledge or have knowledge about a particular domain being represented. An SME generally instructs developers as to what needs to be done and how the SME intends to use the results.

The risk values determined by the SME at 101 may include a numerical or alpha-numeric rating, for example, on a sliding scale between one and ten or 1a, 1b, etc. Having the SME determine these values instead of automating this function will lead to more precise outcomes, allowing the system to focus more on the realities of a project plan, thereby reducing the overall risk associated with the plan. In addition, the use of multiple risk variables also reduces the risk associated with using the SME input. Optionally, in some embodiments, the Fuzzy Engine may direct a subject matter expert to the risk variables that need to be assigned, for example, directing the SME to the numeric range that an assignment must be between and which variable types require assignments at 101.

At 103, a subject matter expert provides the project plan to the Fuzzy Engine. Inputting the comprehensive data into the Fuzzy engine may occur, for example, by scanning a document containing the data, incorporating a spreadsheet or other database into the system, or physically typing or otherwise loading the data manually into the system, as well as through an automated data retrieval or inputting method.

At 107, the Fuzzy Engine assigns fuzzy frames to each of the determined numerical values. The fuzzy frame is an assigned “human grammar” as opposed to computer language, for example, a designation using a word such as low, medium, or high. The human grammar represents a hedge value, more particularly, the human grammar is a single value assigned for a numeric range. For example, where the SME-assigned value is 2, a fuzzy frame of “low” is assigned where a singular low value is defined low=1-4, where 1-4 represents a range of integer values one through four.

The Fuzzy Engine operates using a set of rules, analyzing the information and recommending one or more adjusted task lengths by reaching conclusions using a set of rules and an assigned fuzzy frame. Each rule evaluates the assigned fuzzy frame and determines how to adjust the project length, for example, the rule, “If D1 is H AND D2 is L AND C is L THEN 1 is L2” states that if the task is highly dependent on another task, but other tasks are not highly dependent upon this task and there is a low difficulty rating, then adjust the schedule by L2, where L2 can be any defined extending or shortening period, for example L2=(original predicted task length)*1.04.

The rules implemented within the Fuzzy Engine may be preprogrammed by, for example, a manufacturer, a company selling or offering the system as a service, or a user subject matter expert. The rule set may be based on a user's historical scheduling data, for example, a company's previous year shipping and release schedule, or may be based on other known task-scheduling algorithms. An example set of rules may be configured as follows:

If D1 is HAND D2 is L AND C is L THEN 1 is L2

If D1 is HAND D2 is L AND C is M THEN 1 is L3

If D1 is HAND D2 is L AND C is H THEN 1 is L4

If D1 is HAND D2 is M AND C is L THEN 1 is L3

If D1 is HAND D2 is M AND C is M THEN 1 is L4

If D1 is HAND D2 is M AND C is H THEN 1 is L4

If D1 is HAND D2 is HAND C is L THEN 1 is L3

If D1 is HAND D2 is HAND C is M THEN 1 is L5

If D1 is HAND D2 is HAND C is H THEN 1 is L5

If D1 is M AND D2 is L AND C is L THEN 1 is L2

If D1 is M AND D2 is L AND C is M THEN 1 is L3

If D1 is M AND D2 is L AND C is H THEN 1 is L4

If D1 is M AND D2 is M AND C is L THEN 1 is L3

If D1 is M AND D2 is M AND C is M THEN 1 is L3

If D1 is M AND D2 is M AND C is H THEN 1 is L4

If D1 is M AND D2 is HAND C is L THEN 1 is L3

If D1 is M AND D2 is HAND C is M THEN 1 is L4

If D1 is M AND D2 is HAND C is H THEN 1 is L5

If D1 is L AND D2 is L AND C is L THEN 1 is L1

If D1 is L AND D2 is L AND C is M THEN 1 is L2

If D1 is L AND D2 is L AND C is H THEN 1 is L4

If D1 is L AND D2 is M AND C is L THEN 1 is L1

If D1 is L AND D2 is M AND C is M THEN 1 is L3

If D1 is L AND D2 is M AND C is H THEN 1 is L4

If D1 is L AND D2 is HAND C is L THEN 1 is L3

If D1 is L AND D2 is HAND C is M THEN 1 is L4

If D1 is L AND D2 is HAND C is H THEN 1 is L4

Where
L1=L*1.04;
L2=L*1.08;
L3=L*1.12;
L4=L*1.16, and
L5=L*1.20

At 109, each of the fuzzy frames is evaluated by the system and a subset of rules is determined for each task. Evaluation may occur, for example, through a comparison of an assigned human grammar to each of the rule parameters or through a process of elimination using a sequencing algorithm, where only valid rules remain. Generally, the entire pre-programmed rule set is not utilized, but more than one rule may be applied to a given task where, for example, the numerical ranges overlap in the hedge values defining each human grammar designation.

Once the rules for a given task are determined, the Fuzzy Engine applies these rules to a given task at 111. Applying the rules may cause task lengths to change in direction, lengthening or shortening a projected task length. A task is never discarded after rule analysis at 111, only changes are made to an existing estimate.

At 113, the Engine determines if another task remains. If another task requires analysis, the system returns to assigning fuzzy values at 107. If no tasks remain unanalyzed, the system continues balancing the obtained results at 115.

At 115, the Fuzzy Engine balances the results obtained for each task individually and against each other to obtain a single adjusted project length at 117. The overall balanced period may be altered, for example, through system practice, SME experience, and actual loss to the producer, where such information is incorporated into the Fuzzy Engine system. This feedback may by introduced by, for example, actual project data being input into the system after project completion, dynamically input as tasks are moving through production, or based on other forecasting system data. Feedback information received at 115 may be incorporated into the system to determine if current rules are still applicable and effective or to evaluate changes in the given business environment or domain. If risks are improperly assessed and prioritized within the rules at 109, time can be wasted in dealing with risk of losses that are not likely to occur. In addition, feedback is necessary to ensure that risk assessment rules are not prioritized too highly, which could keep an entity from completely finishing a project or may unnecessarily impede the beginning of a project. The system thereafter ends 119.

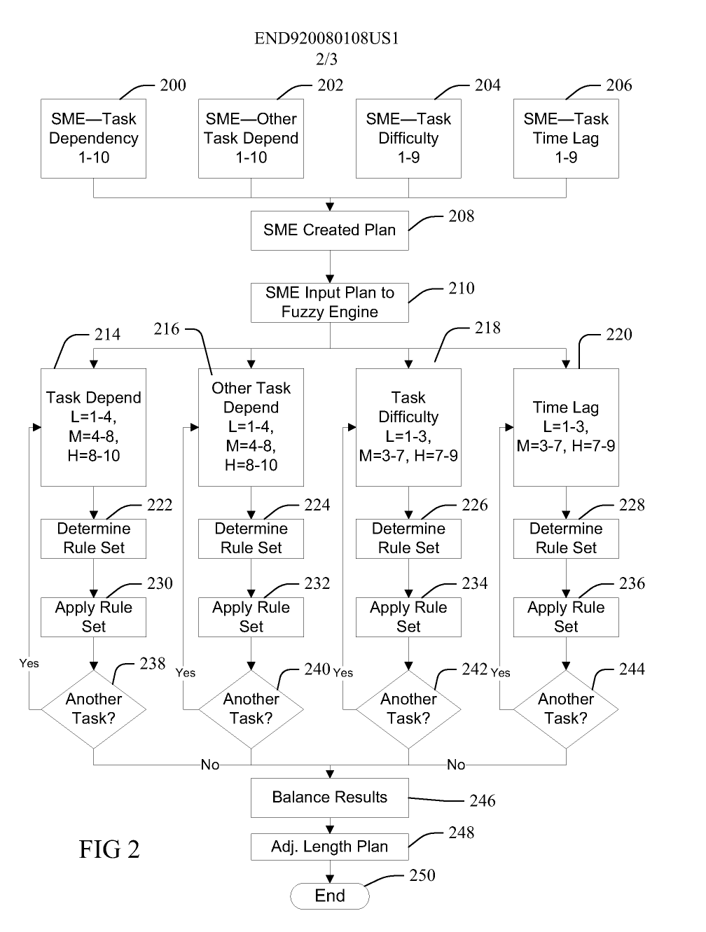

FIG. 2 illustrates illustrating one embodiment for determining overall project length based on risk by an intelligent system using a fuzzy logic method. At 200, the subject matter expert (SME) determines dependencies on each task within a given project, assigning risk values of 1-10 for each task. Task dependency is a relationship in which a task relies on other tasks to be performed before it can be performed. A risk value on the scale between one and ten can demonstrate how partially or completely one project is dependent on another, for example, task 2 cannot be started until task 1 finishes or task 2 cannot start until task 1 is half finished. At 202, the SME determines a task's dependency on other tasks for each task within a project, also assigning risk values of 1-10 for each task. At 204, the SME determines a task's confidence level, its level of projected difficulty, assigning values 1-9 for each task.

At 206, the SME determines if any time lag is relevant, assigning values of 1-9 for each task. Schedule delay is a term in transport modeling which refers to a difference between a desired time or arrival or departure and the actual time. It can refer to a difference in either the forward or backward direction, for example, an estimated time or arrival being early or late. At 208, the SME compiles a comprehensive plan, which is then delivered to the Fuzzy Engine system at 210.

At 214, a fuzzy frame is assigned for each task where the SME determined where other tasks were dependent on the given task. For each assigned value a human grammar value of low, medium, or high is assigned, similarly as described with regards to FIG. 1. At 214, low is assigned where the numerical range is 1-4, medium is assigned where the numerical range is 4-8, and high is assigned where the numerical range is 8-10. The overlap of the hedge ranges is important as multiple rules may be used to analyze the data and produce a more precise adjusted task length. At 216, a fuzzy frame is assigned for each task where the SME determined other task's dependencies on a given task. Low, medium, and high are assigned as discussed previously with regards to 214.

At 218, a fuzzy frame is assigned for each task where the SME determined a task's confidence level or level of difficulty. The hedge values for low, medium, and high are slightly different, with low being assigned where the numerical range is 1-3, medium is assigned where the numerical range is 3-7, and high is assigned where the numerical range is 7-9. As discussed previously, the overlap in hedge values will produce a more precise adjusted task length. At 220, a fuzzy frame is assigned for each task where the SME determined a time lag for a given task. Low, medium, and high are assigned as discussed previously with regards to 218.

At 222-228 the system determines which rules from the pre-defined rules database should be applied for a specific task. Each task may have more than one rule applied due to the overlap created by the overlapping hedge ranges. An example set of rules including the time lag variable may be configured as follows:

If D1 is H AND D2 is L and C is L AND TL is L THEN 1 is L2

If D1 is HAND D2 is L and C is L AND TL is M THEN 1 is L3

If D1 is HAND D2 is L and C is L AND TL is H THEN 1 is L4

If D1 is HAND D2 is L and C is M AND TL is L THEN 1 is L3

If D1 is HAND D2 is L and C is M AND TL is M THEN 1 is L4

If D is HAND D2 is L and C is M AND TL is H THEN 1 is L5

If D1 is HAND D2 is L and C is HAND TL is L THEN 1 is L4

If D1 is HAND D2 is L and C is HAND TL is M THEN 1 is L5

If D1 is HAND D2 is L and C is HAND TL is H THEN 1 is L6

The rules are then applied at 230-236 and the system determines if more tasks require analysis at 238-244. If further tasks require attention, the system returns to assigning fuzzy frames at 214-220. If no further tasks are available, the system continues to the balancing phase at 246.

At 246, the Fuzzy Engine balances all of the resultant data to produce a single adjusted task length 248. The overall balanced period may be altered as discussed previously with regards to FIG. 1 through system practice, SME experience, and actual loss to the producer, where such information is incorporated into the Fuzzy Engine system to determine is current rules are still applicable and effective or to evaluate changes in the given business environment or domain. The system thereafter ends at 250.

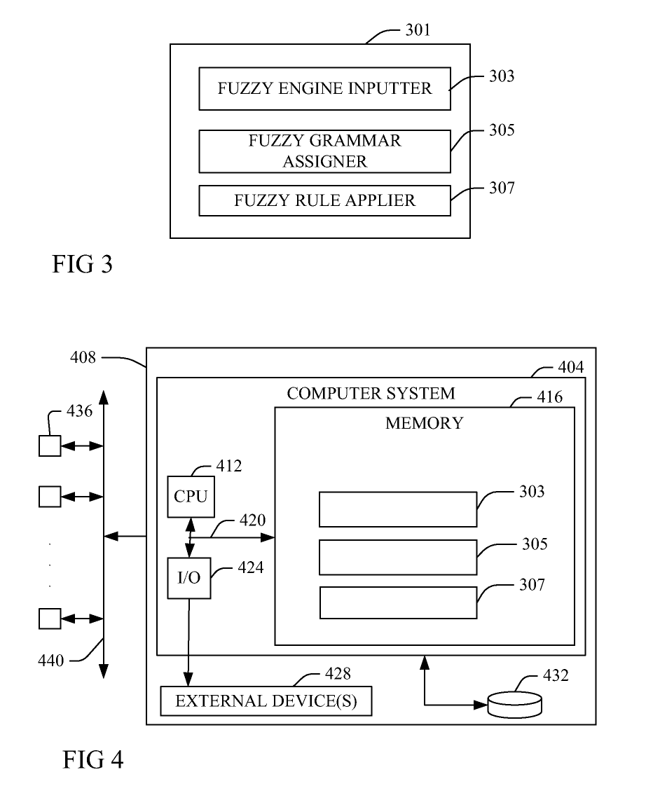

FIG. 3 describes a programmable Fuzzy Engine device 301 configured to determine an overall project length based on risk, comprised of: a Database Presenter logic component 303, a Fuzzy Grammar Assigner logic component 305, and the Fuzzy Data Balancer logic component 307.

The Database Presenter 303 configures the Fuzzy Engine 301 to take data previously compiled by a subject matter expert (SME), accepts the data into the system and separates the entire data into individual tasks which may be separately analyzed. In some embodiments the Database Presenter 303 configures the Fuzzy Engine 301 to direct an SME to the risk variables that need to be assigned, for example, by notifying the SME through a visual display to the numeric range that an assignment must be between or which variable types require assignments.

The Fuzzy Grammar Assigner 305 configures the Fuzzy Engine 301 to assign fuzzy frames for a given task. The fuzzy frame is an assigned “human grammar” as opposed to computer language, for example, a designation using a word such as low, medium, or high as described above with respect to FIGS. 1 and 2. The human grammar designation may be stored within the assigner 305, for example, within a database or other storage location which can be easily accessed by the Fuzzy Data Balancer 307. The designations may additionally be attached to the acquired data, for example, within the previously compiled file or within a newly created file which may only be accessed when the original file is accessed.

The Fuzzy Grammar Assigner 305 configures the Fuzzy Engine 301 to determine which rules apply to a given task. Determining which rules from a rule set to apply to a task may be accomplished through a comparison of an assigned human grammar to each of the rule parameters or through a process of elimination using a sequencing algorithm, where only valid rules remain. Generally, an entire pre-programmed rule set is not utilized, but more than one rule may be applied to a given task where, for example, the numerical ranges overlap in the hedge values defining each human grammar designation.

The Fuzzy Data Balancer 307 configures the Fuzzy Engine 301 to apply each of the determined rules to the tasks, and thereafter balances all produced data into an equalized quantification to produce a single adjusted task length from all the necessary tasks.

### II. Computerized Implementation

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. Thus, embodiments of the present invention comprise methods, apparatus (e.g. systems, devices, etc.) and computer program products. For example, it will be understood that each block of the flowchart illustrations and/or block diagrams of the figures, including FIGS. 1, 2, and 3 as described above, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Referring now to FIGS. 3 and 4, the flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring now to FIG. 4, an exemplary computerized implementation includes a computer system 404 deployed within a computer infrastructure 408 such as a computer or a programmable device such as a personal digital assistant (PDA) or cellular phone. This is intended to demonstrate, among other things, that the present invention could be implemented within a network environment 440 (e.g., the Internet, a wide area network (WAN), a local area network (LAN), a virtual private network (VPN), etc.) in communication with one or more additional computers 436, or on a stand-alone computer infrastructure 408. In the case of the former, communication throughout the network 440 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 404 includes a central processing unit (CPU) 412, a memory 416, a bus 420, and input/output (I/O) interfaces 424. Further, the computer system 404 is shown in communication with external I/O devices/resources 428 and storage system 432. In general, the processing unit 412 executes computer program code, such as the code to implement various components of the process and system for implementing power savings on client-side computational devices as illustrated in FIGS. 1, 2, and 3 and described above, for example, including the Fuzzy Engine Presenter logic component 303, the Fuzzy Grammar Assigner logic component 305, and the Fuzzy Data Balancer logic component 307 components discussed above, which are stored in memory 416 and/or storage system 432. It is to be appreciated that two or more, including all, of these components may be implemented as a single component.

While executing computer program code, the processing unit 412 can read and/or write data to/from the memory 416, the storage system 432, and/or the I/O interfaces 424. The bus 420 provides a communication link between each of the components in computer system 404. The external devices 428 can comprise any devices (e.g., keyboard, pointing device, display, etc.) that enable a user to interact with computer system 404 and/or any devices (e.g., network card, modem, etc.) that enable computer system 404 to communicate with one or more other computing devices.

The computer infrastructure 408 is only illustrative of various types of computer infrastructures for implementing the invention. For example, in one embodiment, computer infrastructure 408 comprises two or more computing devices (e.g., a server cluster) that communicate over a network to perform the various process steps of the invention. Moreover, computer system 404 is only representative of various possible computer systems that can include numerous combinations of hardware.

To this extent, in other embodiments, the computer system 404 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 412 may comprise a single processing unit, or be distributed across one or more processing units in one or more locations, e.g., on a client and server. Similarly, the memory 416 and/or the storage system 432 can comprise any combination of various types of data storage and/or transmission media that reside at one or more physical locations.

Further, I/O interfaces 424 can comprise any system for exchanging information with one or more of the external device 428. Still further, it is understood that one or more additional components (e.g., system software, math co-processing unit, etc.) not shown in FIG. 4 can be included in computer system 404. However, if computer system 404 comprises a handheld device or the like, it is understood that one or more of the external devices 428 (e.g., a display) and/or the storage system 432 could be contained within computer system 404, not externally as shown.

The storage system 432 can be any type of system (e.g., a database) capable of providing storage for information under the present invention. To this extent, the storage system 432 could include one or more storage devices, such as a magnetic disk drive or an optical disk drive. In another embodiment, the storage system 432 includes data distributed across, for example, a local area network (LAN), wide area network (WAN) or a storage area network (SAN) (not shown). In addition, although not shown, additional components, such as cache memory, communication systems, system software, etc., may be incorporated into computer system 404.

Still yet, computer infrastructure 408 is intended to demonstrate that some or all of the components of implementation could be deployed, managed, serviced, etc. by a service provider who offers to implement, deploy, and/or perform the functions of the present invention for others, for example, by licensing methods and browser or application server technology according to the present invention to an internet service providers (ISP) or cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 408 that performs the process steps of the invention for one or more customers, and in return the service provider can receive payment from the customer(s) under a subscription and/or fee agreement and/or the service provider can receive payment from the sale of advertising content to one or more third parties.

The invention also provides for computer-implemented methods according to the present application. In this case, a computer infrastructure, such as computer infrastructure 408, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 404, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for changing project length based on fuzzy logic techniques comprising:
a subject matter expert assigning a pre-determined risk rating to each of a set of tasks;
assigning a human grammar to each of the pre-determined risk ratings for each of the set of tasks, wherein the human grammar is defined by a numeric range, the human grammar being assigned to the risk rating for each value falling within the numeric range;
determining which rules from a set of rules to apply to the task with the assigned human grammar; wherein the set of rules is preprogrammed into a fuzzy engine;
evaluating the tasks with the assigned human grammar using the determined rules;
creating an adjusted time allocation for each task based on the evaluation; and
creating an adjusted task length for the set of tasks based from all of the created adjusted time allocations.

2. The method of claim 1, wherein more than one human grammar may be assigned to the risk rating; wherein more than one rule from the set of rules can apply to one task.

3. The method of claim 2, wherein the risk rating is assigned based on dependencies on the task, the task's dependencies on other tasks, a task difficulty, and a time lag.

4. The method of claim 1, wherein at least one rule is used to evaluate the risk rating and the human grammar, the evaluation results are balanced such that each rule applies to adjust the time allocation.

5. The method of claim 1, wherein the evaluation using the determined rules causes task lengths to change, extending the task length or decreasing the task length; wherein the task length change occurs to an existing estimated task length and no tasks are discarded based on the evaluation.

6. The method of claim 1, wherein the adjusted time allocation is also a function of domain specific input received, where such input is used to improve a product length schedule and overall project length results.

7. A service for changing project length based on fuzzy logic techniques, comprising:
providing a computer infrastructure configured to:
assign a human grammar to each of a predetermined risk rating for each of a set of tasks, wherein the human grammar is defined by a numeric range, the human grammar assigned to the risk rating for each value falling within the numeric range;
determine which rules from a set of rules to apply to the task with the assigned human grammar;
evaluate the tasks with the assigned human grammar using the determined rules;
create an adjusted time allocation based on the evaluation; and
create an adjusted task length for the set of tasks based from all of the created adjusted time allocations.

8. The service of claim 7 comprising the computer infrastructure configured to direct the subject matter expert to assign the risk ratings based on dependencies on the task, the task's dependency on other tasks, a task difficulty, and a time lag.

9. The service of claim 8 comprising the computer infrastructure configured to assign more than one human grammar to the risk rating, wherein more than one rule from the set of rules can apply to one task.

10. The service of claim 9 comprising the computer infrastructure configured to evaluate the risk rating and human grammar using at least one rule, wherein the evaluation results are balanced such that each rule applies to adjust the time allocation.

11. The service of claim 7 comprising the computer infrastructure configured to evaluate using the determined rules, causing task lengths to change, where the task length is extended or decreased, wherein the change in task length occurs to an estimated task length and no tasks are discarded based on the evaluation.

12. The service of claim 7 comprising the computer infrastructure configured to adjust time allocation as a function of domain specific input received, wherein the input is used to improve a product schedule and overall project length results.

13. A method for changing project length based on fuzzy logic techniques, comprising:
producing computer executable program code;
storing the code on a computer readable storage medium; and
providing the program code to be deployed and executed on a computer system, the program code comprising instructions which, when executed on the computer system, cause the computer system to:
assign a human grammar to each of a set of predetermined risk ratings for each of a set of tasks, wherein the human grammar is defined by a numeric range, the human grammar being assigned to a risk rating for each value falling within the numeric range;
determine which rules from a set of rules to apply to the task with the assigned human grammar;
evaluate the tasks with the assigned human grammar using the determined rules;
create an adjusted time allocation for each task based on the evaluation; and
create an adjusted task length for the set of tasks based from all of the created adjusted time allocations.

14. The method of claim 13, the program code comprising instructions, which when executed on the computer system, causes the defined computer system to assign more than one human grammar to the risk rating, wherein more than one rule from the set of rules can apply to one task.

15. The method of claim 14, the program code comprising instructions, which when executed on the computer system, causes the defined computer system to direct a subject matter expert to assign the risk ratings based on dependencies on the task, the task's dependencies on other tasks, a task difficulty, and a time lag.

16. The method of claim 13, the program code comprising instructions, which when executed on the computer system, causes the defined computer system to evaluate the risk rating and human grammar using at least one rule, the evaluation results being balanced such that each rule applies to adjust the time allocation.

17. The method of claim 13, the program code comprising instructions, which when executed on the computer system, causes the defined computer system to change task lengths, extending or decreasing the task length, based on the evaluation, wherein the task length change occurs to an existing estimated task length and no tasks are discarded based on the evaluation.

18. The method of claim 13, the program code further comprising instructions, which when executed on the computer system, causes the defined computer system to adjust time allocation as a function of domain specific input received, where such input is used to improve a product schedule length and overall project length results.

19. A programmable device comprising:
a processing means;
a memory in communication with the processing means; and
a network interface in communication with the processing means and the memory, wherein the processing means is configured to:
assign a human grammar to each of a set of predetermined risk ratings for each of a set of tasks, wherein the human grammar is defined by a numeric range, the human grammar being assigned to the risk rating for each value falling within the numeric range;
determine which rules from a set of rules to apply to the task with the assigned human grammar;
evaluate the tasks with the assigned human grammar using the determined rules;
create an adjusted time allocation for each task based on the evaluation; and
create an adjusted task length for the set of tasks based from all of the created adjusted time allocations.

20. The programmable device of claim 19, wherein the processing means is configured to assign more than one human grammar to the risk ratings, wherein more than one rule from the set of rules can apply to one task.

21. The programmable device of claim 20, wherein the processing means is configured to direct a subject matter expert to assign risk ratings based on dependencies on the task, the task's dependencies on other tasks, a task difficulty, and a time lag.

22. The programmable device of claim 19, wherein the processing means is configured to evaluate the risk rating and human grammar for one task using at least one rule, wherein the evaluation results are balanced such that each rule applies to adjust the time allocation.

23. The programmable device of claim 22, wherein the processing means is configured to change the task lengths based on the evaluation with the at least one rule, extending the task length or decreasing the task length, wherein the task length change occurs to an existing estimated task length and no tasks are discarded based on the evaluation.

24. The programmable device of claim 23, wherein the processing means is further configured to adjust the time allocation as a function of domain specific input received, where such input is used to improve a product length schedule and overall project length results.
